(19) United States
(12) Patent Application Publication
(10) Pub. No.: US 2018/0227336 A1
(43) Pub. Date: Aug. 9, 2018

(54) INFORMATION TRANSMISSION APPARATUS, COMMUNICATION SYSTEM, AND INFORMATION TRANSMISSION METHOD

(71) Applicants: Hiroyuki KANDA, Kanagawa (JP); Junpei MIKAMI, Kanagawa (JP); Atsushi MIYAMOTO, Kanagawa (JP); Hiromu SHICHI, Kanagawa (JP)

(72) Inventors: Hiroyuki KANDA, Kanagawa (JP); Junpei MIKAMI, Kanagawa (JP); Atsushi MIYAMOTO, Kanagawa (JP); Hiromu SHICHI, Kanagawa (JP)

(73) Assignee: Ricoh Company, Ltd., Tokyo (JP)

(21) Appl. No.: 15/872,012

(22) Filed: Jan. 16, 2018

(30) Foreign Application Priority Data
Feb. 6, 2017 (JP) 2017-019602

(51) Int. Cl. H04L 29/06; G06Q 10/10

(52) U.S. Cl. CPC H04L 65/1083; G06Q 10/1095; H04L 67/143; H04L 65/1069; H04L 65/403

(57) ABSTRACT

An information transmission apparatus includes circuitry to manage a log of content data transmitted by one or more of a plurality of communication terminals during a session. The session being established between the plurality of communication terminals to transmit the content data between the plurality of communication terminals. The circuitry also receives information on a transmission destination of the log from at least one of the plurality of communication terminals before the session ends. The circuitry also transmits the log of content data being managed to the transmission destination based on the received information.

### CROSS-REFERENCE TO RELATED APPLICATION

This patent application is based on and claims priority pursuant to 35 U.S.C. § 119(a) to Japanese Patent Application No. 2017-019602, filed on Feb. 6, 2017, in the Japan Patent Office, the entire disclosure of which is hereby incorporated by reference herein.

### BACKGROUND

### Technical Field

Embodiments of the present disclosure relate to an information transmission apparatus, a communication system, and an information transmission method.

### Related Art

With the need for reducing costs or times associated with business trips in recent years, communication systems, which are capable of carrying out videoconferences among remotely located sites through a communication network such as the Internet, are widely used. In such a communication system, for example, a communication terminal is provided at one site and other communication terminal is provided at other site. When conducting a conference using the communication system, the one of the communication terminals captures, for example, an image of a user, collects, for example, words spoken by the user as audio, and transmits the image and the audio as content data to the other communication terminal. The other communication terminal receives the content data and outputs the received content data. When text data is used as another example of the content data, chat messages may be transmitted between or among sites with the communication system.

In some cases, transmission of content data between or among the communication terminals is recorded as a log. However, access to such log of the content data may be limited to accounts set in advance depending on a type of the content data. Due to this, in order to obtain the log of the content data, the communication terminal is required to perform processing such as authentication or selection of a log of content data transmitted between or among the communication terminals.

### SUMMARY

An information transmission apparatus includes circuitry to manage a log of content data transmitted by one or more of a plurality of communication terminals during a session. The session being established between the plurality of communication terminals to transmit the content data between the plurality of communication terminals. The circuitry also receives information on a transmission destination of the log from at least one of the plurality of communication terminals before the session ends. The circuitry also transmits the log of content data being managed to the transmission destination based on the received information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a communication system according to one of the embodiments of the present disclosure;

FIG. 2 is a conceptual diagram illustrating transmission and reception of various data in the communication system;

FIG. 3 is a schematic block diagram illustrating a hardware configuration of a terminal according to one of the embodiments;

FIG. 4 is a schematic block diagram illustrating a functional configuration of the terminal and a management system of the communication system according to one of the embodiment;

FIGS. 5A to 5F are illustrations of example data structures of management tables managed in the management system;

FIG. 6 is a sequence diagram illustrating an example of a login process in which the terminal logs in to the management system;

FIG. 7 is an illustration of an example of an input screen, used for individual settings;

FIG. 8 is a sequence diagram illustrating an example of a process of establishing a communication between the terminals;

FIG. 9 is a sequence diagram illustrating an example of a process of transmitting text data;

FIGS. 10A and 10B are illustrations of examples of display screens;

FIG. 11 is a sequence diagram illustrating an example of a process of requesting an automatic transmission of a log of chat messages;

FIG. 12 is a sequence diagram illustrating an example of a process of terminating a communication between the terminals;

FIG. 13 is a flowchart illustrating an example of a process of preparing for transmitting a chat log;

FIG. 14A is a functional block diagram of a storage unit of the management system;

FIG. 14B is an illustration of an example data structure of a reservation management table;

FIG. 14C is an illustration of an example of a reservation setting input screen;

FIG. 15 is a sequence diagram illustrating an example of a process of setting a reservation; and

FIG. 16 is a flowchart illustrating an example of a process of managing a session performed by the management system.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operation in a similar manner, and achieve a similar result.

Referring to the drawings, an embodiment of the present disclosure is described.

### <<Overall Configuration of Communication System>>

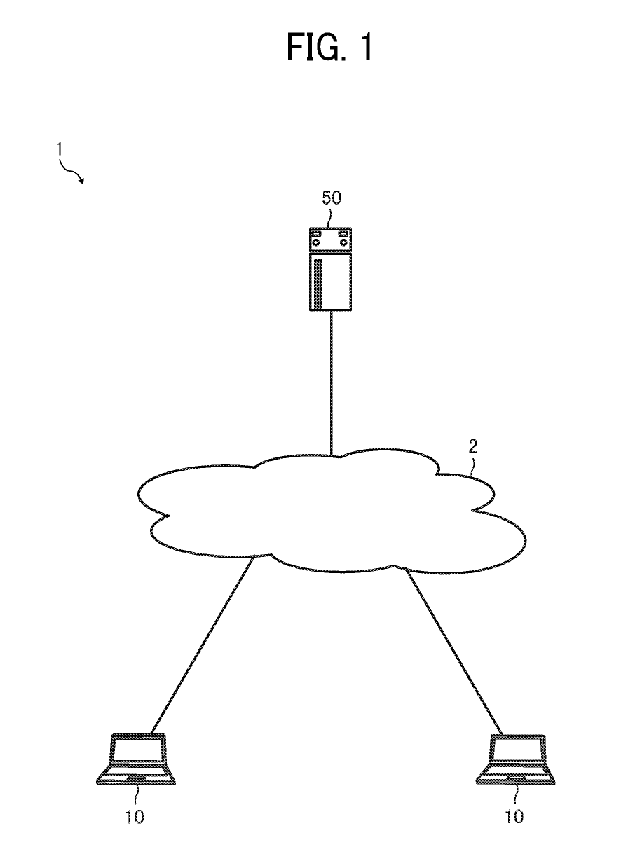

FIG. 1 is a schematic diagram illustrating a communication system 1 according to one of the embodiments (example embodiment) of the present disclosure. The communication system 1 includes a plurality of communication terminals 10 and a communication management system 50. In the following, a “communication terminal” may simply be referred to as a “terminal”, and a “communication management system” may simply be referred to as a “management system”. Although there are a single management system 50 and two terminals 10 illustrated in FIG. 1, three or more terminals 10 may be provided in the communication system 1, and other apparatus(s) and device(s) also may be provided in addition to the terminals 10 and the management system 50.

The communication system 1 includes a data providing system, in which content data is transmitted in one direction from one of the terminals 10 to the other one of the terminals 10, and a communication system, in which content data is transmitted in both directions between or among the plurality of terminals 10. As an example of the communication system 1, a videoconference system, a video telephone system, a chat system, or the like is used. In the following description, content data includes image data, audio data, and text data, the communication system 1 is a videoconference system having a chat function, and the terminal 10 is a general-purpose personal computer (PC). The image data may be a video image or a still image, or both of the video image and the still image. In the description of the following embodiments, the term “videoconference” and the term “teleconference” are interchangeably used.

The plurality of terminals 10 and the management system 50 are communicably connected to each other through a communication network 2. Each of the plurality of terminals 10 is installed at an arbitrary site such as a meeting room of a Tokyo office in Japan or a meeting room of a New York office in the United States of America, for example. The plurality of terminals 10 establishes a communication among the sites by transmitting and receiving the image data, the audio data and the text data. The terminals 10 are used not only in a plurality of remote offices but also in arbitrary site(s) such as in the same office, outdoors and indoors, or outdoors and outdoors. When being used outside, the terminals 10 establish a wireless communication using a mobile phone communication network, for example. The terminals 10 are not limited to be used for a videoconference but also used for a general conversation between or among users.

The management system 50 manages login authentication of the terminals 10 and the communication established by the terminals 10, for example. The management system 50 may be installed at the same site as the terminal 10 or may be installed at a different site from the terminal 10.

In the present embodiment, the communication network 2 is implemented using, for example, a local area network (LAN), a dedicated line, and/or the Internet. The communication network 2 may not only include a wired network, but also a wireless network such as a network in compliance with Wireless Fidelity (WiFi) and Bluetooth (registered trademark).

Examples of other apparatuses and/or devices that are able be connected to the communication network 2 include a relay device, a program providing system, and a maintenance system. The relay device relays content data between or among the terminals 10. The program providing system transmits a terminal program to the terminal 10 and transmits a communication management program to the management system 50. The maintenance system maintains, manages, and repairs at least the terminal 10 or the management system 50.

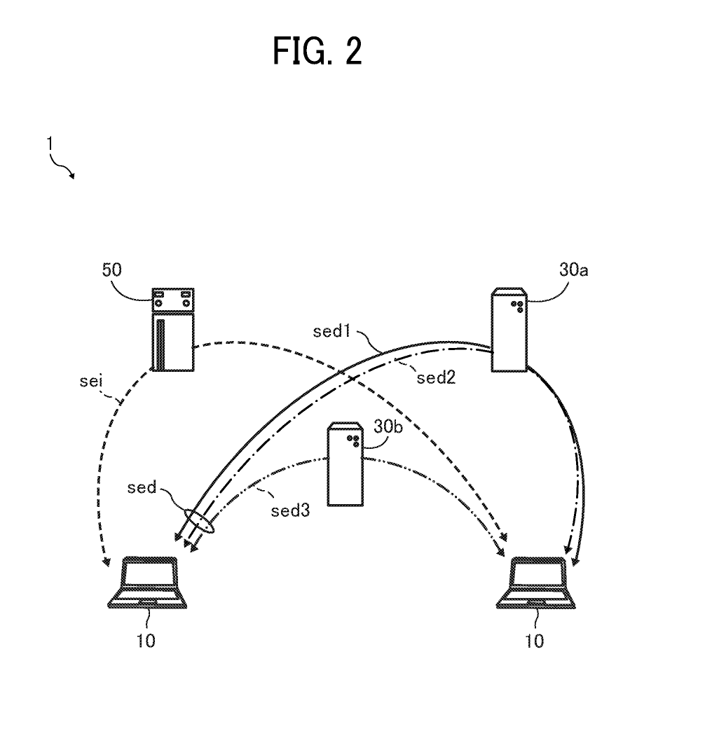

FIG. 2 is a conceptual diagram illustrating transmission and reception of various data in the communication system of FIG. 1. In FIG. 2, a relay device 30a and a relay device 30b, individually, relay content data between the plurality of terminals 10. The communication between or among the terminals 10 is not limited to this, however, in some of the embodiments, a peer to peer (P2P) system is used to establish a communication between or among the terminals 10, for example. As illustrated in FIG. 2, the management system 50 establishes a management data communication session “sei” with each one of the terminals 10, to transmit and receive various management data including call control message data between the terminals 10 in the communication system 1. Additionally, a session sed 1 for transmitting image data and a session sed 2 for transmitting audio data are established between the terminals 10 via the relay device 30a. Further, a session sed 3 for transmitting text data via the relay device 30b is established between the terminals 10. In the following description, arbitrary one or more sessions among the session sed 1, the session sed 2, and the session sed 3 for transmitting the content data between the communication terminals 10 is represented as a session sed. The image data may include basic data required to reproduce an image and extension data for enhancing a quality of the image to be reproduced by being combined with the basic data. In this case, the session sed 1 for transmitting the image data includes a session for transmitting and receiving the basic data, and another session for transmitting and receiving the extension data. Additionally, in some of the embodiments, the management system 50 has a function of the relay device 30a or the relay device 30b and the session sed between the terminals 10 is established via the management system 50.

### <Hardware Configuration of Example Embodiment>

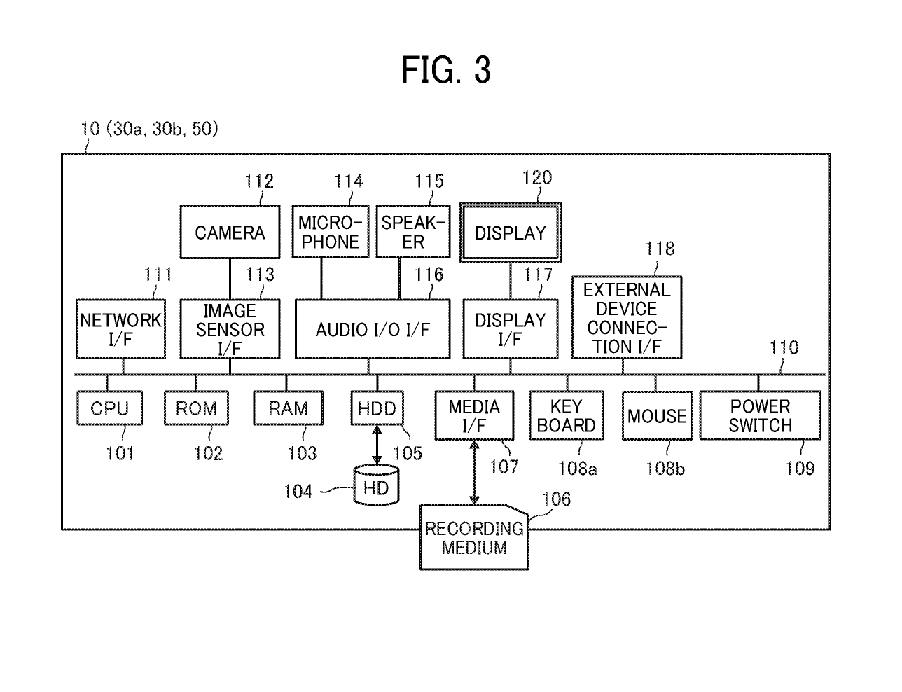

With reference to FIG. 3, a hardware configuration of the terminal 10 according to one of the embodiments (example embodiment) is described. FIG. 3 is a schematic block diagram illustrating a hardware configuration of the terminal 10. As an example of the terminal 10, a general-purpose personal computer (PC) having a communication function is used in the following description. In a case where the terminal 10 is a dedicated device, the terminal 10 also has the same or a corresponding hardware configuration as described below.

The terminal 10 includes a central processing unit (CPU) 101 that controls overall operation of the terminal 10, a read-only memory (ROM) 102 that stores a program, such as an initial program loader (IPL), used for driving the CPU 101, a random-access memory (RAM) 103 used as a work area for the CPU 101, a hard disk (HD) 104 that stores programs, such as a terminal control program used for controlling the terminal 10, and various types of data including content data, a hard disk drive (HDD) 105 that reads and writes the various data from and to the HD 104 under the control of the CPU 101, a medium I/F 107 that reads and writes data from and to a recording medium 106 such as a flash memory and an integrated circuit (IC) card, a keyboard 108a and mouse 108b each of which receives user instruction, a power switch 109 that turns on/off the power of the terminal 10, and a network interface (I/F) 111 that transmits data using the communication network 2.

The terminal 10 further includes a built-in camera 112 that captures an image of a subject and obtains image data under control of the CPU 101, an image sensor IN 113 that controls driving of the camera 112, a built-in microphone 114 that receives sound input, a built-in speaker 115 that outputs the sound, a sound input/output ii/F 116 that processes inputting/outputting of a sound signal between the microphone 114 and the speaker 115 under control of the CPU 101, a display 120 that outputs an image generated based on the image data, a display I/F 117 that transmits the image data to the display 120 under control of the CPU 101, an external device connection I/F 118 that connects the terminal 10 to various external devices, and a bus line 110, such as an address bus and a data bus, to electrically connect the above-described elements to each other as illustrated in FIG. 3.

The camera 112 includes a lens, and solid-state imaging device that converts an image or moving images (video) of an object into electronic data through photoelectric conversion. As the solid-state imaging device, for example, a complementary metal oxide semiconductor (CMOS) or a charge-coupled device (CCD) is used.

The external device connection I/F 118 is capable of connecting an external device such as an external camera, an external microphone, or an external speaker by using a universal serial bus (USB) cable or the like.

Each of the management system 50, the relay device 30a and the relay device 30b has a hardware configuration that is the same as or similar to that of the terminal 10, and the descriptions thereof are omitted here. In some of the embodiments, each of the management system 50, the relay device 30a and the relay device 30b does not include a part of the hardware configuration described above, for example, the camera 112, the microphone 114, and the speaker 115, which are included in the hardware configuration of the terminal 10.

### <<Functional Configuration of Example Embodiment>>

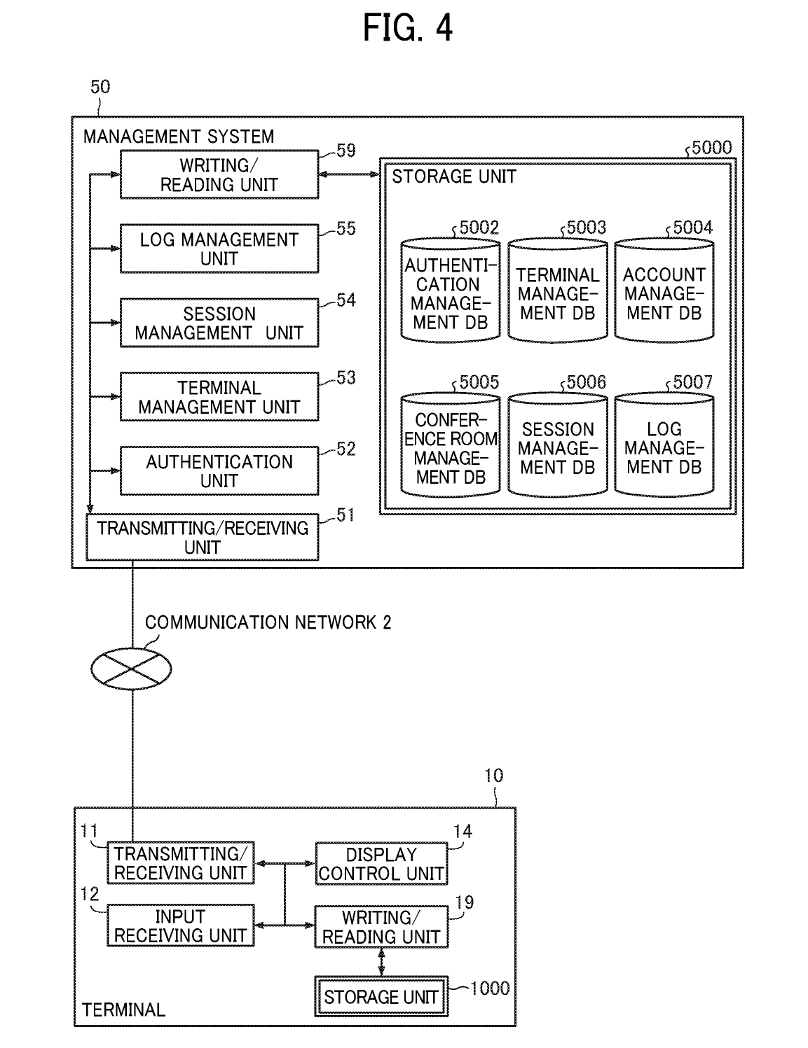

A functional configuration of the communication system 1 according to the present embodiment (example embodiment) is described. FIG. 4 is a schematic block diagram illustrating a functional configuration of the terminal 10 and the management system 50 of the communication system 1. In FIG. 4, the terminal 10 and the management system 50 are communicably connected to each other through the communication network 2.

### <Functional Configuration of Management System>

The management system 50 includes a transmitting/receiving unit 51, an authentication unit 52, a terminal management unit 53, a session management unit 54, a log management unit 55, and a write/reading unit 59. These units are functions that are implemented by operating any of the elements illustrated in FIG. 3 with instructions from the CPU 101 according to a control program for the management system 50 expanded from the HD 104 to the RAM 103. The management system 50 also includes a storage unit 5000, which is implemented with the ROM 102, RAM 103, and/or HDD 105. The storage unit 5000 stores a plurality of databases (DBs), which are represented as tables as described below.

### (Authentication Management Table)

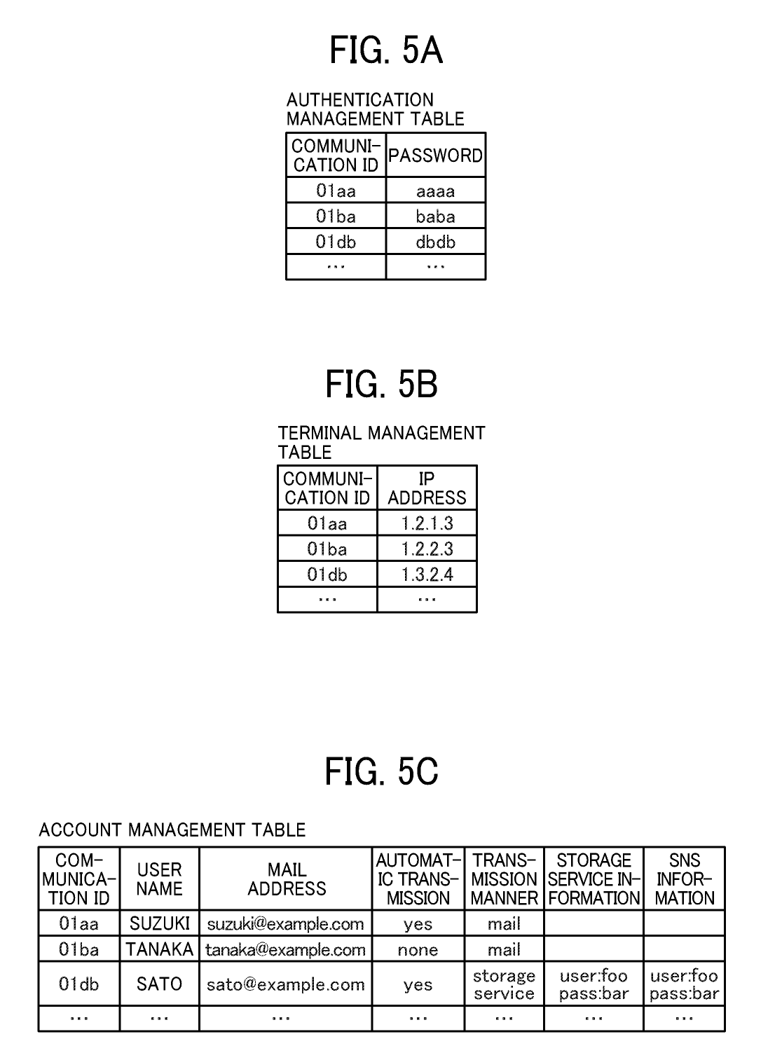

FIG. 5A is an illustration of an example data structure of an authentication management table. The storage unit 5000 stores an authentication management DB 5002 configured as the authentication management table, as illustrated in FIG. 5A. In the authentication management table, a communication identifier (ID) for each one of the terminals 10 managed by the management system 50 and a corresponding password for authentication are managed in association with each other. The communication ID, which may be referred to as a contact ID, is information for identifying a communication destination in the communication system 1. Examples of the communication ID include, but not limited to, terminal identification information for identifying the terminal 10, such as a terminal ID, and user identification information for identifying a user of the terminal 10, such as a user account name. In the following description, the communication IDs corresponding to a terminal 10aa and a terminal 10ba, each of which are one of the terminals 10, are respectively, “01aa” and “01ba”, which are the account names input by users.

### (Terminal Management Table)

FIG. 5B is an illustration of an example data structure of a terminal management table. The storage unit 5000 stores a terminal management DB 5003 configured as the terminal management table, as illustrated in FIG. 5B. In the terminal management table, a communication ID and an internet protocol (IP) address of each terminal 10 are managed in association with each other.

### (Account Management Table)

FIG. 5C is an illustration of an example data structure of an account management table. The storage unit 5000 stores an account management DB 5004 configured as the account management table, as illustrated in FIG. 5C. In the account management table, a communication ID, a user name, a mail address of each user operating each terminal 10, information indicating whether a log of chat messages generated in the session sed 3, in which each terminal 10 participates is automatically transmitted, information on a transmitting manner (transmitting means) for each terminal 10, namely, how automatic transmission of the log is performed, and information used for the automatic transmission of a log for each terminal 10 are stored in association with each other. Examples of the information used for automatic transmission include a user ID used in an online storage service, such as dropbox (registered trademark), storage service information such as a password, and social networking service (SNS) information, such as a destination (user name) and a password used in the SNS. The information indicating whether the automatic transmission is performed includes “yes” indicating the automatic transmission is set and “none” indicating the automatic transmission is not set.

### (Conference Room Management Table)

FIG. 5D is an illustration of an example data structure of a conference room management table. The storage unit 5000 stores a conference room management DB 5005 configured as the conference room management table, as illustrated in FIG. 5D. In the conference room management table, a conference room ID, a session ID corresponding to the session sed, communication IDs of the terminals 10 participating in the session sed, and a state of the session sed are managed in association with each other. The conference room ID is not an actual identification information assigned to the conference room used in real life, but is commonly used by the terminals 10 to participate in the same session sed in a process described later.

### (Session Management Table)

FIG. 5E is an illustration of an example data structure of a session management table. The storage unit 5000 stores a session management DB 5006 configured as the session management table, as illustrated in FIG. 5E. In the session management table, a session ID corresponding to the session sed, a conference room ID used for the session sed, a start time of a conference, and an end time of the conference, communication IDs of the terminals 10 participating in the session sed, and communication ID(s) of the terminal(s) 10 that is/are target(s) for the automatic transmission of a history log of chat messages, which are generated in the session sed 3 are managed in association with each other.

### (Log Management Table)

FIG. 5F is an illustration of an example data structure of a log management table. The storage unit 5000 stores a log management DB 5007 configured as the log management table, as illustrated in FIG. 5F. In the log management table, a session ID corresponding to the session sed, a time to transmit a chat message in the session sed, a communication of a transmission source of transmitting the chat message, and contents of the chat message are managed in association with each other.

Each functional unit of the management system 50 is described below with reference to FIG. 4. The transmitting/receiving unit 51 of the management system 50, which is implemented by the instructions of the CPU 101 and the network IN 111, transmits and receives various data (or information) to or from a counterpart terminal, namely the terminal 10, through the communication network 2.

The authentication unit 52 of the management system 50 authenticates a login source according to the instructions from the CPU 101.

The terminal management unit 53 of the management system 50 manages a state of the terminal 10 according to the instructions from the CPU 101.

The session management unit 54 of the management system 50 manages the session sed established between or among the terminals 10 according to the instructions from the CPU 101.

The log management unit 55 of the management system 50 manages a log of chat messages transmitted in the session sed established between or among the terminals 10 according to the instructions from the CPU 101.

The writing/reading unit 59 of the management system 50 stores various data in the storage unit 5000 and reads various data stored in the storage unit 5000 according to the instructions from the CPU 101.

### <Functional Configuration of Terminal>

Referring to FIG. 4, the terminal 10 includes a transmitting/receiving unit 11, an input receiving unit 12, a display control unit 14, and a writing/reading unit 19. These units are functions that are implemented by operating any of the elements illustrated in FIG. 3 with instructions from the CPU 101 according to the control program for the terminal 10 expanded from the HD 104 to the RAM 103. The terminal 10 also includes a storage unit 1000 implemented with the ROM 102, the RAM 103, and/or the MD 105 illustrated in FIG. 3.

The transmitting/receiving unit 11 of the terminal 10 transmits and receives various data (or information) to or from a counterpart terminal, namely the management system 50, through the communication network 2 by the instructions from the CPU 101.

The input receiving unit 12 of the terminal 10 receives the instructions from the CPU 101 and various operation input by a user with the keyboard 108a and the mouse 108b.

The display control unit 14 of the terminal 10 causes the display 120 to output an image, according to the instructions from the CPU 101, using the display I/F 117.

The writing/reading unit 19 of the terminal 10 stores various data in the storage unit 1000 and reads various data stored in the storage unit 1000 according to the instructions from the CPU 101.

### <<Processes According to Example Embodiment>>

Processes according to the present embodiment are described below. The processes performed in the communication system 1 is described below.

### (Login Process)

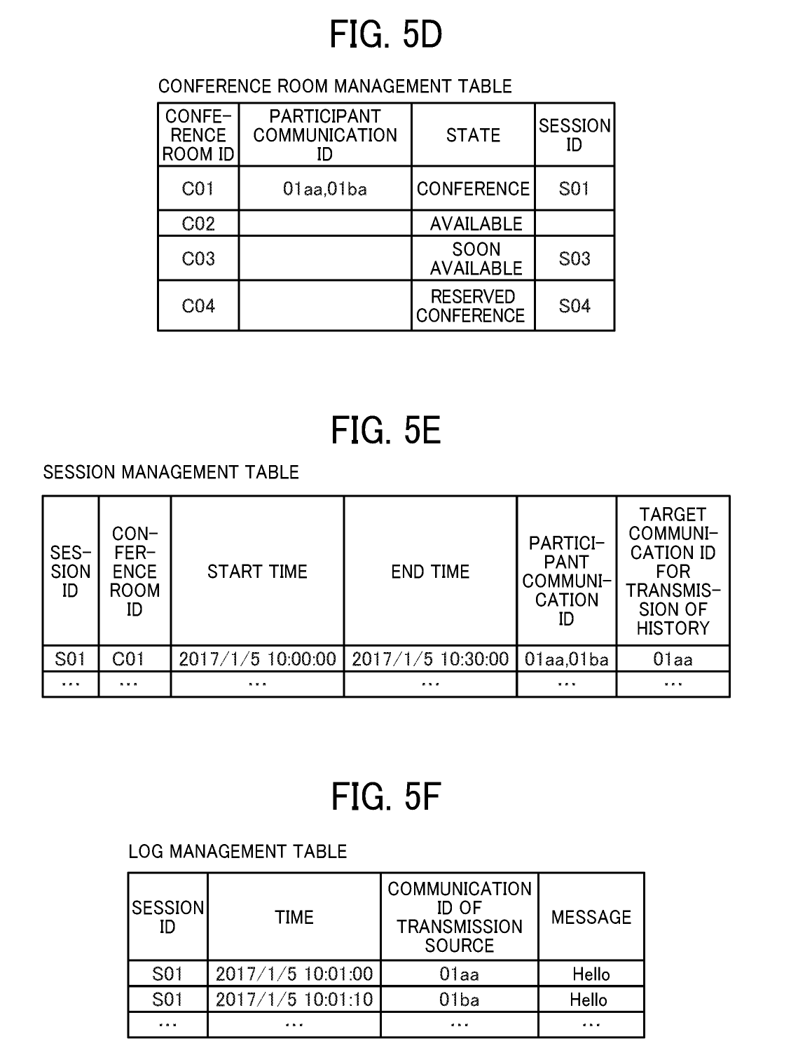

FIG. 6 is a sequence diagram illustrating an example of a login process in which the terminal 10 logs in to the management system 50. In the following description of the login process, the terminal 10aa, which is one of the terminals 10, logs in to the management system 50, for example. Each of the other terminals 10 than the terminal 10aa also logs in the management system 50 in a same way as the terminal 10aa does.

The input receiving unit 12 of the terminal 10aa receives an input of an account name, which is a communication ID, and a password (S1). The transmitting/receiving unit 11 of the terminal 10aa transmits a login request including the communication ID and the password accepted by the input receiving unit 12 to the management system 50 (S2). In some of the embodiments, the communication ID and the password of the terminal 10aa are stored in the storage unit 1000 in advance. In this case, the transmitting/receiving unit 11 of the terminal 10aa transmits a login request including the communication II) and the password that are read from the storage unit 1000 to the management system 50.

The transmitting/receiving unit 51 of the management system 50 receives the login request sent from the terminal 10aa. When receiving the login request, the management system 50 acquires an IP address of the terminal 10aa, which is a source of the login request (login request source).

The authentication unit 52 of the management system 50 searches the authentication management table (see FIG. 5A) using the communication ID and the password included in the login request as search keys, and authenticates the terminal 10aa according to a determination whether a communication II) and a password that are the same as those in the login request are managed in the authentication management table (S3). In the following description, the login request source is assumed to be determined to have an authorized right by the authentication unit 52. When the login request source is determined to have the authorized right, the terminal 10aa logs in to the management system 50, and then the session sei between the terminal 10aa and the management system 50 is established.

The terminal management unit 53 of the management system 50 records in the terminal management table (see FIG. 5B) the communication ID of the login request source, which is the terminal 10aa, and the IP address of the login request source, which is the terminal 10aa, in association with each other (S4). The transmitting/receiving unit 51 of the management system 50 transmits authentication result information indicating an authentication result determined by the authentication unit 52 to the terminal 10aa, which is the login request source (S5). The transmitting/receiving unit 11 of the terminal 10aa, which is the login request source, accordingly, receives the authentication result information.

After the terminal 10aa logs in to the management system 50, the input receiving unit 12 of the terminal 10aa receives a request for a setting input screen used for individual settings, input according to user operation. The request for the input screen may be received before starting communication with the other terminal(s) 10 or during the communication with the other terminal(s) 10. When the input of the request for the input screen according to user operation is accepted, the display control unit 14 of the terminal 10aa causes the display 120 to display the input screen.

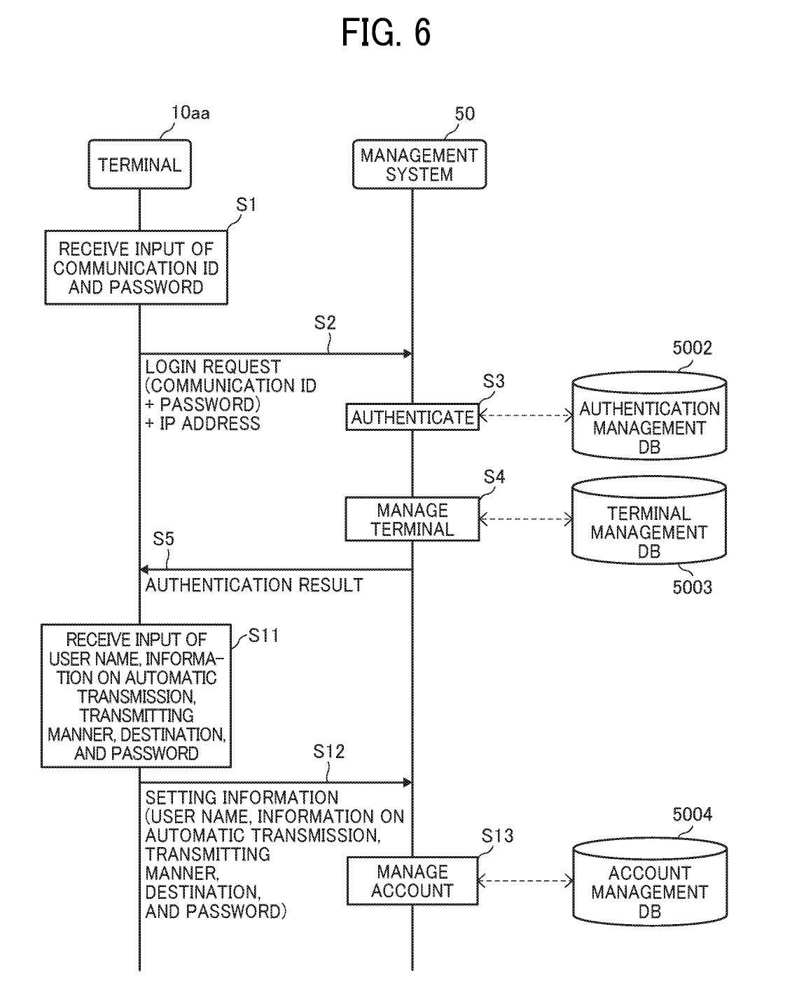

FIG. 7 is an illustration of an example of the input screen, used for individual settings, according to the present embodiment. As illustrated in FIG. 7, the input screen includes a radio button 301 for selecting whether to automatically transmit a log of chat messages after the session sed is over. Additionally, the input screen includes a pull-down menu 302 for selecting a transmitting manner for the automatic transmission. With the pull-down menu 302, for example, mail, online storage service, and SNS, which are set in advance, is selectable as the transmitting manner. The input screen also includes input fields 303 for inputting a mail address and a user name as a destination for transmission according to the selected transmitting manner. The input screen further includes input fields 304 for passwords used in using the online storage service or the SNS. Additionally, the input screen includes an input field 305 for a user name of the own terminal, namely the terminal 10aa. In some of the embodiments, the storage unit 1000 of the terminal 10aa stores, in advance, default setting values as setting values for each of settings described above. In this case, the display control unit 14 may output the input screen having the default setting values, which are stored in the storage unit 1000 in advance.

When the user selects the settings regarding whether or not to perform the automatic transmission and the transmitting manner, inputs the user name, the destination, and the password, for example, and presses a “SET” button 306, the input receiving unit 12 of the terminal 10aa accepts those input, namely setting information (S11).

The transmitting/receiving unit 11 of the terminal 10aa transmits to the management system 50 the setting information including information regarding whether or not to perform the automatic transmission, the transmission manner (if selected), the destination (a mail address and a user ID) (if input), and the password (if input), each of which is selected or input in S11 (S12).

The transmitting/receiving unit 51 of the management system 50 receives the setting information transmitted from the terminal 10aa. The writing/reading unit 59 of the management system 50 stores the information regarding whether or not to perform the automatic transmission, the transmission manner (if selected), the destination (mail address, user name) (if input), and the password (if input) included in the setting information in the account management table (See FIG. 5C) in association with the communication II) of the terminal 10aa (S13).

### (Process of Establishing Communication Between or Among Terminals)

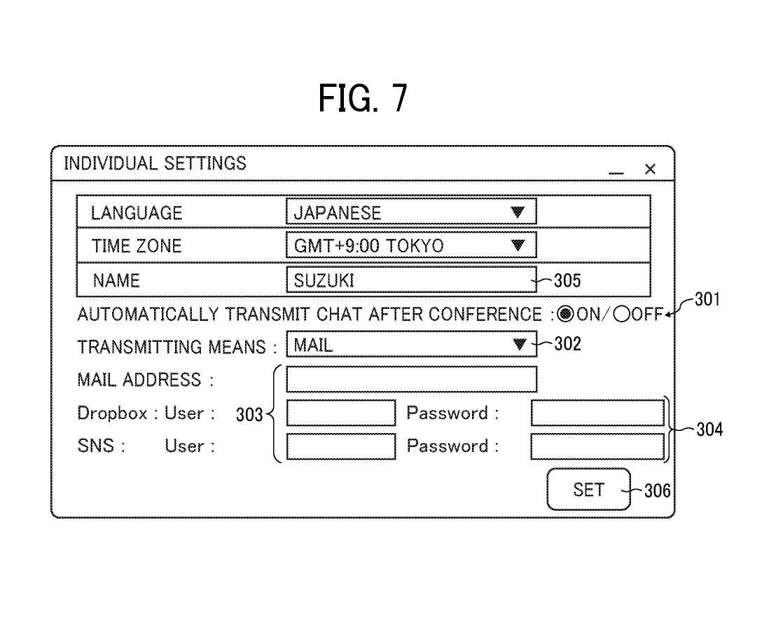

A process of establishing a communication between or among the terminals 10 is described below. FIG. 8 is a sequence diagram illustrating an example of the process of establishing a communication between the terminal 10aa and the terminal 10ba. In the following description of the process of establishing a communication, the terminal 10aa and the terminal 10ba, which have logged in to the management system 50, start communication for a videoconference, however, the embodiments are not limited to this and the other terminals 10 than the terminal 10aa and the terminal 10ba are also able to start by the same process.

In the present embodiment, as one example, the number of the videoconferences to be held at the same time by the terminals 10 at a client side is limited to four. The terminal 10, accordingly, appoints one of the four conference room Ms and sends a participation request to the management system 50. The conference room ID, here, is not an actual identification information assigned to the conference room used in real life, but is commonly used by the terminals 10 to participate in the same session sed.

When the terminal 10aa receives an input from the user to appoint the conference room ID, the input receiving unit 12 accepts the input of the conference room ID (S214). In the following description, the input conference room ID is assumed to be “C01”. When the input of the conference room is accepted, the transmitting/receiving unit 11 of the terminal 10aa transmits to the management system 50 a participation request for participation in a conference corresponding to the input conference room II), “C01” (S22-1).

The transmitting/receiving unit 51 of the management system 50 receives the participation request transmitted from the terminal 10aa. The session management unit 54 of the management system 50 refers to the conference room management table and checks whether there is any other of the terminal 10 participating in the session sed, using the conference room ID “C01” included in the participation request. Table 1-1 is one example of the conference management table regarding the conference room II) “C01”. As described in Table 1-1, when there is no communication ID associated with the conference room ID “C01”, namely, when there is no terminal 10 participating in the session sed using the conference room ID “C01”, the session management unit 54 generates a new session ID (here, referred to as “S01”) and establishes the session sed corresponding to the new session ID (S23-1). In the present embodiment, the relay device 30a relays the image data and the management system 50 relays the text data between the terminals 10. The session management unit 54, according to the present embodiment, establishes the session sed 1 and the session sed 2 for transmitting, respectively, the image data and the audio data between the relay device 30a and the terminal 10aa, and the session sed 3 for transmitting the text data between the terminal 10aa and the management system 50.

TABLE 1-1

| CONFERENCE | PARTICIPANT | | |
|---|---|---|---|
| ROOM ID | COMMUNICATION ID | SATE | SESSION ID |
| C01 | | VACANT | |

The session management unit 54 of the management system 50 records in the conference room management table the communication II), “01 as”, of the terminal 10aa, which is a participation request source, state information, “CONFERENCE”, and the session II) newly generated, “S01”, in association with the conference room II) “C01” included in the participation request (S24-1). Table 1-2 is another example of the conference management table regarding the conference room M “C01”. Due to the above-described process, the conference management table is updated from Table 1-1 to Table 1-2.

TABLE 1-2

| | PARTICIPANT | | |
|---|---|---|---|
| CONFERENCE | COMMUNICATION | | SESSION |
| ROOM ID | ID | SATE | ID |
| C01 | 01aa | CONFERENCE | S01 |

Further, the session management unit 54 of the management system 50 adds, in the session management table, a record including the generated session ID, the conference room ID “C01”, which is included in the participation request, a current time as a start time of the session sed (for example, 2017/1/5 10:00:00), and the communication ID “01aa” of the terminal 10aa, which participates in the session sed. Table 2-1 is one example of the session management table regarding the session ID “S01”. Due to the above-described process, the record described in Table 2-1 is added to the session management table.

TABLE 2-1

| | | | | PARTICIPANT | TARGET |
|---|---|---|---|---|---|
| SESSION | CONFERENCE | START | END | COMMUNICATION | COMMUNICATION ID FOR |
| ID | ROOM ID | TIME | TIME | ID | LOG TRANSMISSION |
| S01 | C01 | 2017/1/5 | | 01aa | |
| | | 10:00:00 | | | |

When the terminal 10ba receives the same input as the terminal 10aa, namely when a user of the terminal 10ba appoints the same conference room ID, “C01”, as the user of the terminal 10aa, the input receiving unit 12 of the terminal 10ba accepts the input of the conference room ID (S21-2). When the input of the conference room ID is accepted, the transmitting/receiving unit 11 of the terminal 10ba transmits to the management system 50 a participation request including the input conference room ID “C01” (S22-2).

The transmitting/receiving unit 51 of the management system 50 receives the participation request transmitted from the terminal 10ba. The session management unit 54 of the management system 50 refers to the conference room management table and checks whether there is any other of the terminals 10 participating in the session sed, using the conference room ID “C01” included in the participation request.

As described in Table 1-2, when there is a communication ID associated with the conference room ID “C01”, namely when there is any other of the terminals 10 participating in the session sed using the conference room ID “C01”, the session management unit 54 causes the terminal 10ba, which is a participation request source, to participate in the session sed of the session ID “S01” corresponding to the conference room ID “C01” (S23-2). Through this, the session management unit 54 establishes the session sed 1 and the session sed 2 for transmitting, respectively, the image data and the audio data between the relay device 30a and the terminal 10ba, and the session sed 3 for transmitting the text data between the terminal 10ba and the management system 50.

The session management unit 54 of the management system 50 records in the conference room management table the communication ID “01ba” of the terminal 10ba, which is the participation request source, in association with the conference room ID “C01” included in the participation request (S24-2). Table 1-3 is still another example of the conference management table. Due to the above described processing, the conference management table is updated from Table 1-2 to Table 1-3.

TABLE 1-3

| | PARTICIPANT | | |
|---|---|---|---|
| CONFERENCE | COMMUNICATION | | SESSION |
| ROOM ID | ID | SATE | ID |
| C01 | 01aa, 01ba | CONFERENCE | S01 |

The session management unit 54 of the management system 50 adds the communication ID “01ba” of the terminal 10ba, which participates in the conference, to the session management table in association with the conference room ID “C01” included in the participation request. Table 2-2 is another example of the session management table regarding the session ID “S01”. Due to the above-described process, the session management table is updated from Table 2-1 to Table 2-2.

TABLE 2-2

| | | | | PARTICIPANT | TARGET |
|---|---|---|---|---|---|
| SESSION | CONFERENCE | START | END | COMMUNICATION | COMMUNICATION ID FOR |
| ID | ROOM ID | TIME | TIME | ID | LOG TRANSMISSION |
| S01 | C01 | 2017/1/5 | | 01aa, 01ba | |
| | | 10:00:00 | | | |

When the terminal 10aa and the terminal 10ba participate in the session sed, the relay device 30a relays the image data and the audio data between the terminal 10aa and the terminal 10ba, which participate in the same session sed. Additionally, the management system 50 relays the text data between the terminal 10aa and the terminal 10ba, which participate in the same session sed.

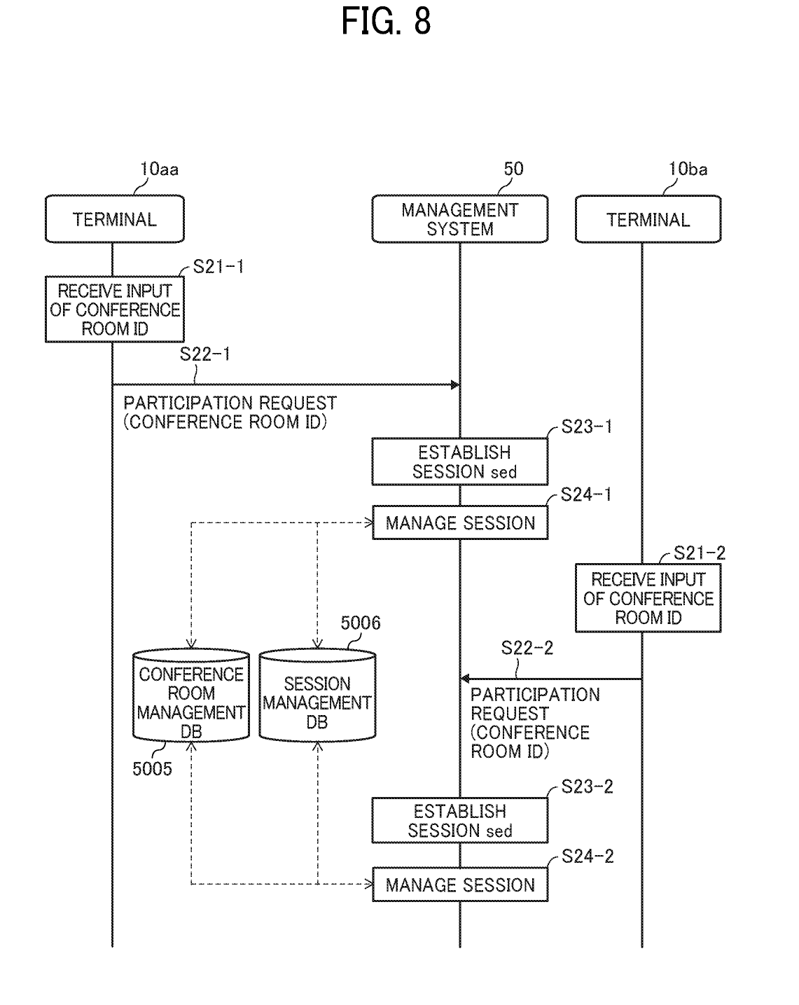

A process of transmitting the text data between the terminal 10aa and the terminal 10ba after the establishment of the session sed is described below. FIG. 9 is a sequence diagram illustrating an example of the process of transmitting text data.

When the terminal 10aa receives an input of text data indicating a message to be sent to the terminal 10ba according to user operation, the input receiving unit 12 of the terminal 10aa accepts the input of the text data (S31). The transmitting/receiving unit 11 of the terminal 10aa transmits the text data input in S31 to the management system 50 through the session sed 3 (S32).

The transmitting/receiving unit 51 of the management system 50 receives the text data transmitted from the terminal 10aa. The log management unit 55 of the management system 50 adds, to the log management table, a record including the session ID “S01”, a receiving time when the text data is received, the communication II) “01 aa” of the text data transmission source, and contents of the chat message represented as the text data (for example, “Hello”) (S33). Table 3-1 and Table 3-2 are examples of the log management table. Due to S33, the record of Table 3-2 is added to the log management table of Table 3-1.

TABLE 3-1

| | | | |
|---|---|---|---|
| | | SOURCE | |
| SESSION ID | TIME | COMMUNICATION ID | MESSAGE |

TABLE 3-2

| | | SOURCE | |
|---|---|---|---|
| SESSION ID | TIME | COMMUNICATION ID | MESSAGE |
| S01 | 2017/1/5 | 01aa | Hello |
| | 10:01:00 | | |

The transmitting/receiving unit 51 of the management system 50 transmits the text data transmitted from the terminal 10aa in S32 to the terminal 10ba participating in the same session sed 3 (S34).

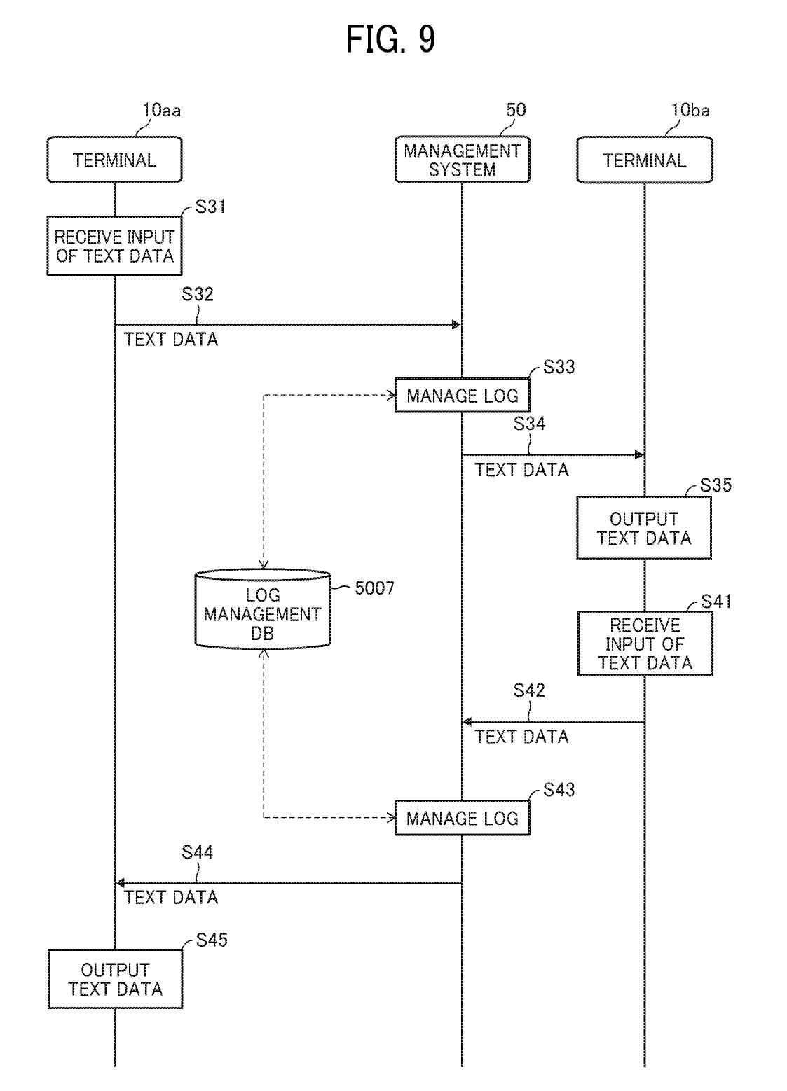

The transmitting/receiving unit 1 of the terminal 10ba receives the text data transmitted from the management system 50. The display control unit 14 of the terminal 10ba causes the display 120 of the terminal 10ba to output the image data transmitted from the terminal 10aa in the session sed 1 and the chat message represented as the text data transmitted in the session sed 3 from the terminal 10aa (S35). FIG. 1.0A is an illustration of one example of a display screen in S35. As illustrated in FIG. 10A, the display screen includes a check box 401a to accept a request for the automatic transmission of a log of the chat messages after the conference.

When the terminal 10ba receives an input of text data indicating a message to be sent to the terminal 10aa according to user operation, the input receiving unit 12 of the terminal 10ba accepts the input of the text data (S41). The transmitting/receiving unit 11 of the terminal 10ba transmits the text data input in S41 to the management system 50 through the session sed 3 (S42).

The transmitting/receiving unit 51 of the management system 50 receives the text data transmitted from the terminal 10ba. The log management unit 55 of the management system 50 adds, to the log management table, a record including the session ID “S01” corresponding to the session sed, a time when the text data is received, the communication ID “01ba”, which is a text data transmission source, and contents of the chat message represented as the text data (for example, “Hello”) (S43). Table 3-3 is another example of the log management table. Due to S43, the log management table is updated from Table 3-2 to Table 3-3.

TABLE 3-3

| | | SOURCE | |
|---|---|---|---|
| SESSION ID | TIME | COMMUNICATION ID | MESSAGE |
| S01 | 2017/1/5 | 01aa | Hello |
| | 10:01:00 | | |
| S01 | 2017/1/5 | 01ba | Hello |
| | 10:01:10 | | |

The transmitting/receiving unit 51 of the management system 50 transmits the text data transmitted from the terminal 10ba in S42 to the terminal 10aa participating in the same session sed 3 (S44).

The transmitting/receiving unit 11 of the terminal 10aa receives the text data transmitted from the management system 50. The display control unit 14 of the terminal 10aa causes the display 120 of the terminal 10aa to output the image data transmitted from the terminal 10ba with the session sed 1 and the chat message represented as the text data transmitted from the terminal 10ba with the session sed 3 and the chat message transmitted to the terminal 10ba with the session sed 3 (S45). FIG. 10B is an illustration of one example of a display screen of the terminal 10aa in S45. As illustrated in FIG. 10B, the display screen includes a check box 401b to accept a request for the automatic transmission of the log of the chat messages after the conference.

Each time when the user input the text data with the terminal 10aa, the process from S31 to S35 is performed. Similarly, each time when the user inputs the text data with the terminal 10ba, the process from S41 to S45 is performed. Through this, each display screen of the display 120 of the terminal 10aa and the terminal 10ba outputs the text data that is transmitted or received by the terminal 10aa or the terminal 10ba with the session sed 3.

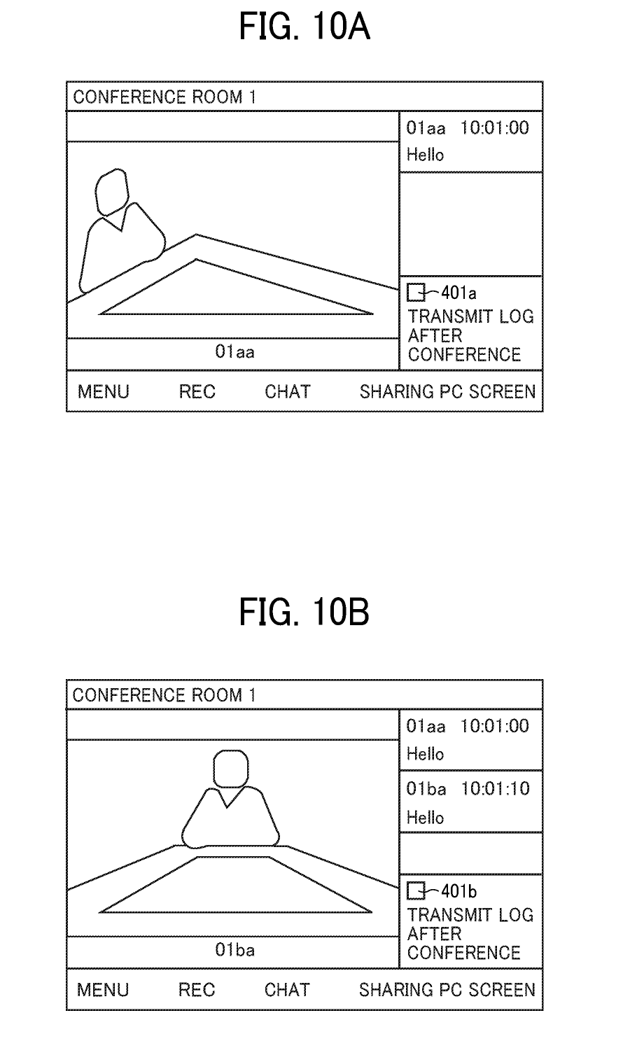

FIG. 11 is a sequence diagram illustrating an example of a process of requesting automatic transmission of a log of chat messages. In the following description, the terminal 10aa is assumed to request for the log of the chat messages. Similarly, the terminal 10ba is able to request for the log of the chat messages.

When the terminal 10aa receives user operation to input or remove a check in or from the check box 401b of FIG. 10B, the input receiving unit 12 of the terminal 10aa accepts the request or a cancel of the request (request cancel) for the transmission of the log of the chat messages after the conference (S51).

The transmitting/receiving unit 11 of the terminal 10aa transmits to the management system 50 the accepted request or request cancel according to the acceptance of the request or the request cancel for the transmission of the log of the chat messages after the conference (S52).

The transmitting/receiving unit 51 of the management system 50 receives information on the request or the request cancel transmitted from the terminal 10aa. When the request for the transmission of the log is received, the session management unit 54 of the management system 50 records, in a record having the session ID “S01” of the session sed in which the terminal 10aa is participating, in the session management table, the communication “01aa” of the terminal 10aa as a target communication ID for log transmission (S53). When the request cancel is received, the session management unit 54 of the management system 50 deletes the communication ID “01aa” of the terminal 10aa recorded as a target communication ID for the log transmission, from the record having the session ID, “S01”, of the session in which the terminal 10aa is participating, in the session management table (S53).

Table 2-3 is still another example of the session management table. When the request for the transmission of the log of chat messages is transmitted by the terminal 10aa, the session management table is updated from Table 2-2 to Table 2-3.

TABLE 2-3

| | | | | PARTICIPANT | TARGET |
|---|---|---|---|---|---|
| SESSION | CONFERENCE | START | END | COMMUNICATION | COMMUNICATION ID FOR |
| ID | ROOM ID | TIME | TIME | ID | LOG TRANSMISSION |
| S01 | C01 | 2017/1/5 | | 01aa | 01aa |
| | | 10:00:00 | | | |

### (Communication Termination Process Between or Among Terminals)

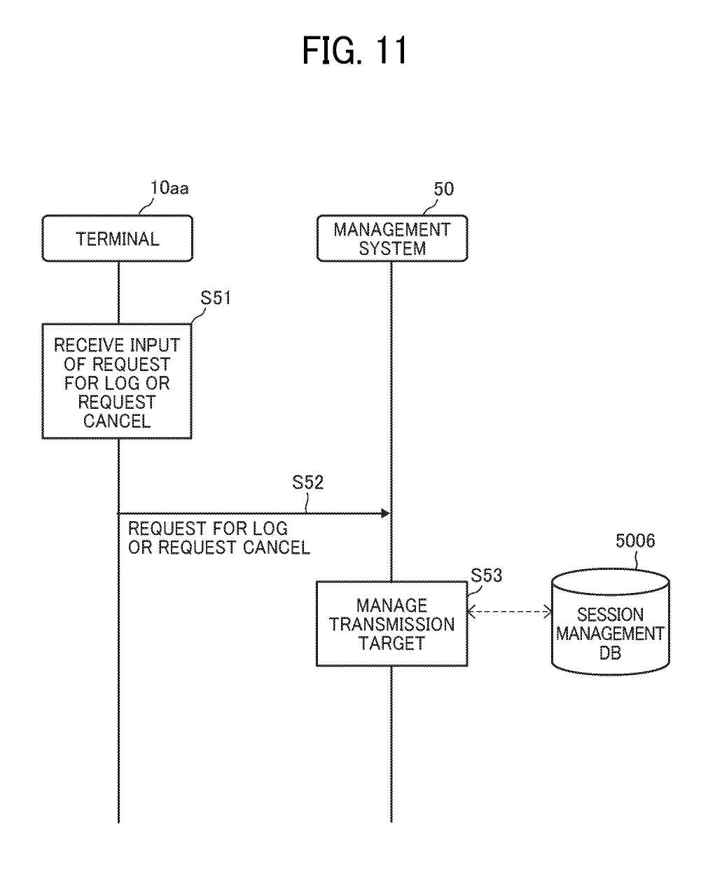

A process of ending a videoconference, namely a process of terminating communication between or among the terminals 10 is described below. FIG. 12 is a sequence diagram illustrating an example of the process of terminating communication between the terminals 10.

When the terminal 10aa receives an input according to user operation, requesting for ending the videoconference, the input receiving unit 12 of the terminal 10aa accepts the input of a videoconference end request (S61-1). When the input of the videoconference end request is accepted, the transmitting/receiving unit 11 of the terminal 10aa transmits to the management system 50 an exit request including the conference room ID “C01”, which is being used with the terminal 10aa (S62-1).

The transmitting/receiving unit 51 of the management system 50 receives the exit request transmitted from the terminal 10aa. The session management unit 54 of the management system 50 disconnects the terminal 10aa, which is a source of the exit request (exit request source), from the session sed (S63-1). Through this, the session management unit 54 disconnects the session sed 1 and the session sed 2, which are used for transmitting, respectively, the image data and the audio data between the relay device 30a and the terminal 10ba, and the session sed 3, which is used for transmitting the text data between the terminal 10aa and the management system 50.

The session management unit 54 of the management system 50 deletes from the conference room management table the communication II) “01aa” corresponding to the terminal 10aa, which is the exit request source, which is associated, in the videoconference table, with the conference room II) “C01” included in the exit request (S64-1). Table 1-4 is still another example of the conference management table. Due to S64-1, the conference room management table is updated from Table 1-3 to Table 1-4.

TABLE 1-4

| | PARTICIPANT | | |
|---|---|---|---|
| CONFERENCE | COMMUNICATION | | SESSION |
| ROOM ID | ID | SATE | ID |
| C01 | 01ba | CONFERENCE | S01 |

After deleting the communication ID “01aa”, the session management unit 54 of the management system 50 determines whether the terminal 10aa, which is the exit request source, is the last terminal 10 being connected to the session sed. The session management unit 54 determines that the terminal 10aa, which is the exit request source, is not the last terminal 10 being connected to the session sed, when any communication ID(s) of the terminals 10, which is/are participating in the session sed, is/are recorded in associated with the conference room ID “C01” in the conference room management table (see Table 1-4). With this determination, the session management unit 54 remains the state information associated with the conference room ID “C01” as “CONFERENCE” in the conference room management table.

When the terminal 10ba receives an input according to user operation, requesting for ending the videoconference, the input receiving unit 12 of the terminal 10ba accepts the input of a videoconference end request (S61-2). When the video conference end request is accepted, the transmitting/receiving unit 11 of the terminal 10ba transmits to the management system 50 an exit request including the conference room ID “C01”, which is being used with the terminal 10ba (S62-2).

The transmitting/receiving unit 51 of the management system 50 receives the exit request transmitted from the terminal 10ba. The session management unit 54 of the management system 50 disconnects the terminal 10ba, which is an exit request source, from the session sed (S63-2). Through this, the session management unit 54 disconnects the session sed 1 and the session sed 2, which are for transmitting, respectively, the image data and the audio data between the relay device 30a and the terminal 10ba, and the session sed 3, which is for transmitting the text data between the terminal 10ba and the management system 50.

The session management unit 54 of the management system 50 deletes from the conference room management table the communication ID “01ba” corresponding to the terminal 10ba, which is exit request source associated, in the videoconference table, with the conference room ID “C01” included in the exit request (S64-2).

After deleting the communication ID “01ba”, the session management unit 54 of the management system 50 determines whether the terminal 10ba, which is the exit request source, is the last terminal 10 being connected to the session sed. The session management unit 54 determines that the terminal 10ba, which is the exit request source, is the last terminal being connected to the session sed, when no communication ID of the terminals 10 that are participating in the session sed is recorded in associated with the conference room ID “C01” in the conference room management table. With this determination, the session management unit 54 changes the state information associated with the conference room ID “C01” to “VACANT” and deletes the session ID in the conference room management table. The session management unit 54 adds a current time to the record, in which the conference room ID “C01” is included, as the end time of the session sed.

Table 1-5 is still another example of the conference management table. Table 2-4 is still another example of the session management table. Due to S64-2, the conference room management table is updated from Table 1-4 to Table 1-5. Due to S64-2, the session management table is updated from Table 2-3 to Table 2-4.

TABLE 1-5

| CONFERENCE | PARTICIPANT | | |
|---|---|---|---|
| ROOM ID | COMMUNICATION ID | SATE | SESSION ID |
| C01 | | VACANT | |

TABLE 2-4

| | | | | PARTICIPANT | TARGET |
|---|---|---|---|---|---|
| SESSION | CONFERENCE | START | END | COMMUNICATION | COMMUNICATION ID FOR |
| ID | ROOM ID | TIME | TIME | ID | LOG TRANSMISSION |
| S01 | C01 | 2017/1/5 | 2017/1/5 | 01aa, 01ba | 01aa |
| | | 10:00:00 | 10:30:00 | | |

After deleting the session II) “S01” from the conference room management table, the session management unit 54 of the management system 50 transmits an instruction to transmit a chat log including the session ID to the log management unit 55 of the management system 50. In response to the instruction to transmit the log of the chat messages, the log management unit 55 starts preparing for transmitting the chat log (S65).

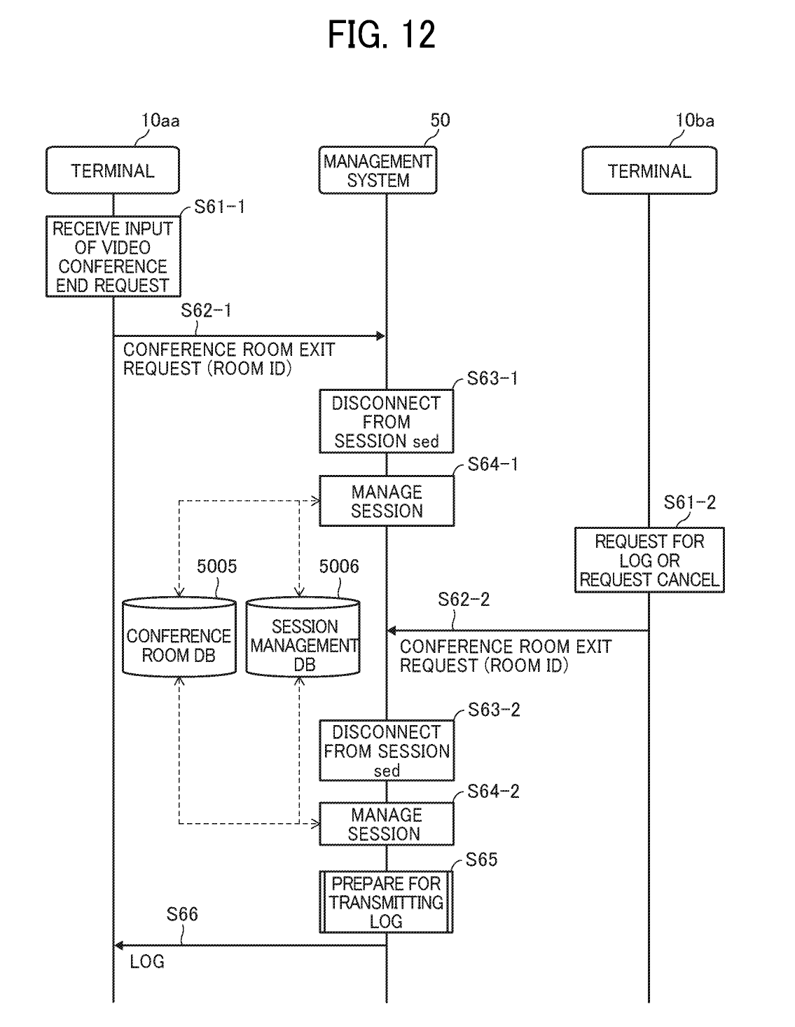

FIG. 13 is a flowchart illustrating an example of a process of preparing for transmitting a log of chat messages. A detailed description of S65 is described with reference to FIG. 13. The log management unit 55 searches the session management table (see Table 2-4) using the received session ID “S01” as a search key and obtains the communication ID “01aa” as target communication ID for the log transmission (S65-1).

The log management unit 55 of the management system 50 extracts communication ID(s) from the communication Ms “01aa, 01ba” of the terminal 10aa and the terminal 10ba, which had participated in the session sed, except for the communication ID(s) associated with the information on automatic transmission indicating “none” in the account management table (FIG. 5C) (S65-2). The communication ID “01aa” is extracted from the account management table of FIG. 5C.

The log management unit 55 of the management system 50 operates logical OR of the communication ID obtained in S65-1 and extracted in S65-2 and generates a list of transmission destinations of the log of the chat messages (S65-3). The method of determining the transmission destination of a log of chat messages is not particularly limited, as long as the method is based on the settings set with each terminal 10, which participates in the session sed. For example, the log management unit 55 may generate a list of transmission destinations by logical AND in place of the logical OR in S65-3.

The log management unit 55 of the management system 50 determines whether one or more communication IDs are included in the list generated in S65-3 (S65-4). If S65-4 determines that no communication ID is included in the list (NC)), the log management unit 55 determines not to transmit the log of the chat messages and ends the process.

If S65-4 determines that one or more communication IDs are included in the list (YES), the log management unit 55 of the management system 50 obtains information to be included in the log of the chat messages. In this process, the log management unit 55 searches the session management table (see Table 2-4) using the session ID “S01” received from the session management unit 54 as a search key, reads the corresponding conference room ID, start time “2017/1/5 10:00:00”, end time “2017/1/5 10:30:00”, and communication II) “01 aa, 01ba” of the terminals 10, which participate in the session sed. The log management unit 55 also searches the account management table (see FIG. 5C) using the read communication IDs “01aa, 01ba” as a search key, and reads the corresponding user names “Suzuki, Tanaka”. The log management unit 55 further searches the log management table (see Table 3-3) using the session ID “S01” received from the session management unit 54 as a search key, and obtains, for each record, the corresponding time, communication II) of the transmission source, and messages. The log management unit 55 generates the log of the chat messages by using the read information described above (S65-5). Table 4 is one example of the log generated.

TABLE 4

Conference start time: 2017/1/5 10:00:00
Conference end time: 2017/1/5 10:30:00
Conference Participant: Suzuki, Tanaka
Conference Room ID: C01
2017/1/5 10:00:00 (Suzuki) Hello
2017/1/5 10:00:10 (Tanaka) Hello

The log management unit 55 of the management system 50 searches the account management table (see FIG. 5C) using the communication II) included in the list of transmission destinations generated in S65-3 as a search key, and reads the corresponding transmission manner (S65-6). When the read transmission manner is “mail”, the log management unit 55 searches the account management table using the communication ID of the transmission destination as a search key, and obtains a corresponding mail address. When the read transmission manner is “storage service”, the log management unit 55 searches the account management table using the communication ID of the transmission destination as a search key, and obtains a corresponding user name and password as storage service information. When the read transmission manner is “SNS”, the log management unit 55 searches the account management table using the communication H) of the transmission destination as a search key, and obtains a corresponding user name and password as SNS information.

The transmitting/receiving unit 51 of the management system 50 transmits the log of the chat messages generated in S65-5 to the destination Obtained in S65-6 (S66). For example, when a mail address is read in S65-6, the transmitting/receiving unit 51 transmits the log of the chat messages to the read mail address. The transmitting/receiving unit 11 of the terminal 10aa receives the log of the chat messages delivered from a mail server.

### <<<Modification A of Example Embodiment>>>

A modification A of the example embodiment is described. In particular, difference from the above-described example embodiment is described. After causing the terminal 10, which is an exit request source, to disconnect from a session sed (see S63-1, S63-2 of FIG. 12), the session management unit 54 of the management system 50 manages, in S64-1 or S64-2, the session sed as follows.

The session management unit 54 of the management system 50 deletes from the conference room management table the communication ID “01aa” or “01ba” associated with a conference room ID included in the exit request, in the same manner as the example embodiment described above. After deleting the communication ID, the session management unit 54 determines whether the terminal 10aa or the terminal 10ba, which is disconnected from the session sed, is the last terminal 10 being connected to the session sed. When the terminal 10aa or the terminal 10ba is not the last terminal 10 being connected to the session sed, the session management unit 54 waits for the last terminal 10 being disconnected.

When determining that the terminal 10aa or the terminal 10ba is the last terminal 10 being connected to the session sed, the session management unit 54 changes, in the conference room management table, the state information associated with the conference room ID “C01”, which is used by the last terminal 10, to “SOON AVAILABLE”. Table 1-6 is still another example of the conference management table. Due to the above described process, the conference management table is updated from Table 1-4 to Table 1-6.

TABLE 1-6

| CONFERENCE | PARTICIPANT | | SESSION |
|---|---|---|---|
| ROOM ID | COMMUNICATION ID | SATE | ID |
| C01 | | SOON | S01 |
| | | AVAILABLE | |

After changing the state information to “SOON AVAILABLE”, the session management unit 54 starts a timer to measure a predetermined time, for example, 10 minutes, which is set by, for example, a user or a designer. When a participation request for participation in the session sed is transmitted from the terminal 10 participating in the session sed to the management system 50 before the set time elapses, the session management unit 54 connects the terminal 10, which is the participation request source, to the session sed. This process is the same as the process of S21-1 to S24-1 and the process of S21-2 to S24-2.

When the participation request for participation in the session sed is not transmitted from the terminal 10 participating in the session sed to the management system 50 before the set time elapses, the session management unit 54 terminates the session sed. Subsequently, in the conference room management table, the session management unit 54 changes the state information associated with the conference room ID used by the last terminal 10 to “VACANT” and deletes the session ID (Table 1-5). Furthermore, the session management unit 54 records an end time of the session sed in association with the conference room ID used by the last terminal 10 in the session management table (see Table 2-4). After deleting the session ID, the session management unit 54 transmits an instruction to transmit a log to the log management unit 55.

In response to the instruction, the log management unit 55 of the management system 50 starts preparing for transmitting the log of chat messages in the same manner as S65, and the transmitting/receiving unit 11 transmits the log of the chat messages in the same manner as S66.

According to the modification A of the example embodiment, even when being accidentally disconnected from the session sed, the terminal 10 is able to reconnect to the same session sed. This allows the terminal 10 to receive the log of the chat messages including chat messages after the reconnection.

### <<Modification B of Example Embodiment>>

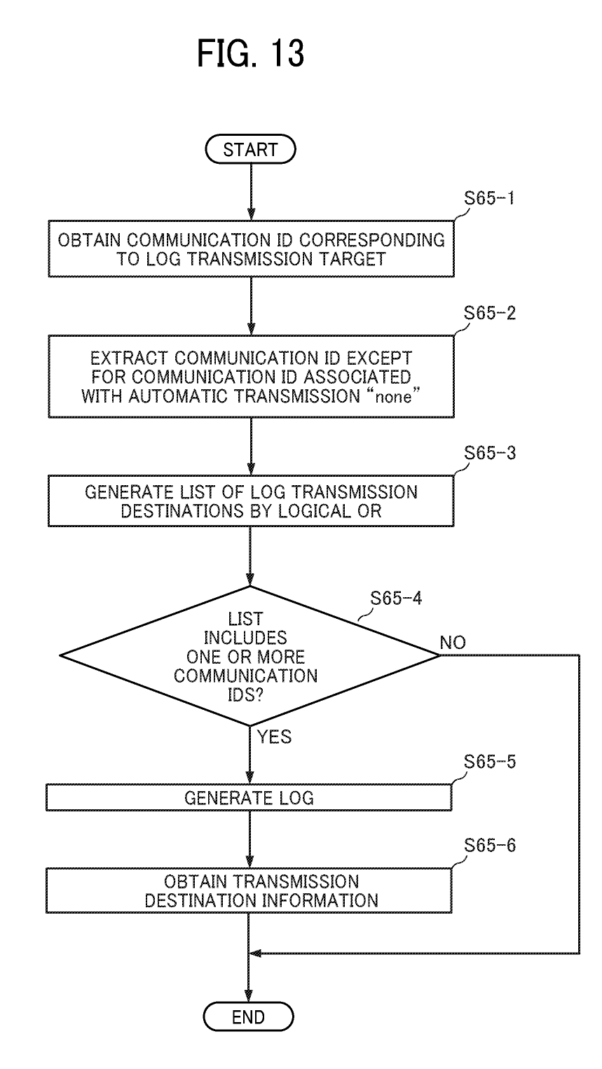

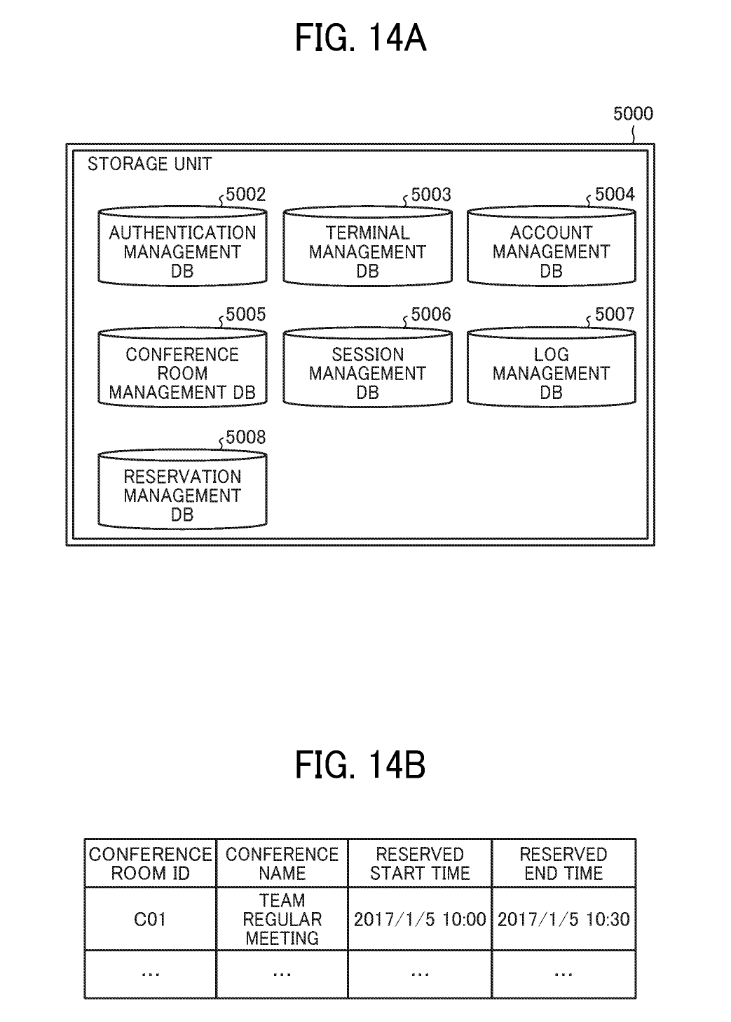

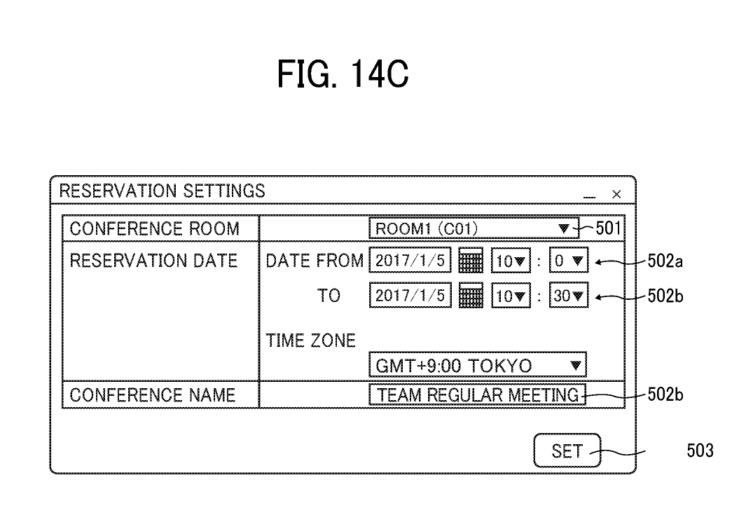

A modification B of the example embodiment is described. In particular, difference from the above-described example embodiment is described. FIG. 14A is a functional block diagram of the storage unit 5000 of the management system 50 according to the modification B of the example embodiment. The storage unit 5000 stores a reservation management DB 5008 configured as a reservation management table, as illustrated in FIG. 14B, in addition to each table described in the description of the example embodiment.

### (Reservation Management Table)

FIG. 14B is an illustration of an example data structure of the reservation management table. In the reservation management table, a conference room ID used for a conference that is reserved (reserved conference), a conference name of the reserved conference, a start time of the reserved conference, and an end time of the reserved conference are stored in association with each other.

### (Reservation Setting Process)

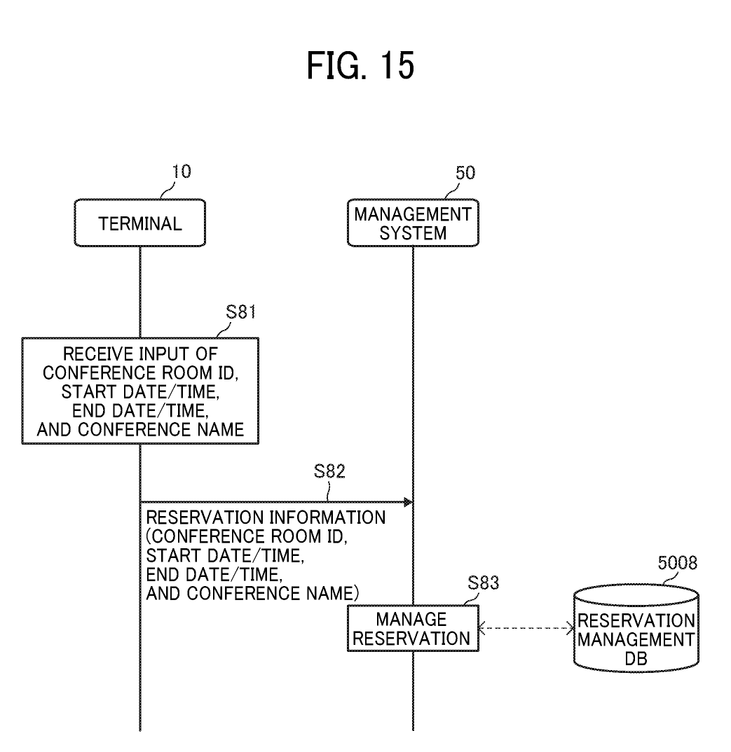

FIG. 15 is a sequence diagram illustrating an example of a process of setting a reservation (reservation setting process). The reservation setting process is described with reference to FIG. 15.

After the terminal 10 logs in to the management system 50, the input receiving unit 12 of the terminal 10 receives a request for a reservation setting input screen, when a user of the terminal 10 inputs the request. When the input of the request for the reservation setting input screen according to user operation is accepted, the display control unit 14 of the terminal 10 causes the display 120 to display the reservation setting input screen.

FIG. 14C is an illustration of an example of the reservation setting input screen. The reservation setting input screen includes a pull-down menu 501 for selecting a conference room ID to be used for a conference related to the reservation (reserved conference), an input field 502a for a start date and time of the reserved conference, an input field 502b for an end date and time of the conference, and an input field 502c for a conference name of the reserved conference. When the user inputs the conference room ID, the start date and time, the end date and time, and the conference name with the reservation setting input screen and presses a “SET” button 503, the input receiving unit 12 of the terminal 10 accepts these operation inputs (reservation information) (S81)

The transmitting/receiving unit 11 of the terminal 10aa transmits to the management system 50 the conference room ID, the start date and time of, the end date and time, and the conference name, namely the reservation information, which are input in S81 (S82).

The transmitting/receiving unit 51 of the management system 50 receives the reservation information transmitted from the terminal 10. The writing/reading unit 59 of the management system 50 records the conference room the start date and time, the end date and time, and the conference name included in the reservation information in the reservation management table in association with each other (S83).

### (Process of Establishing and Terminating Communication Among or Between Terminals)

The user who has set the reservation of the conference, of the terminal 10, informs, for example, by mails, to the other user(s) who is(are) to participate in the reserved conference, the reservation information including the conference room ID, the start date and time, the end date and time, the conference name. Each user is to participate in the conference at a time of the start date and time by the process of S21-1 to S24-1 of FIG. 8 using the terminal 10. Additionally, each user is to end the conference at a time of the end date and time by the process of S61-1 to S64-1 of FIG. 12.

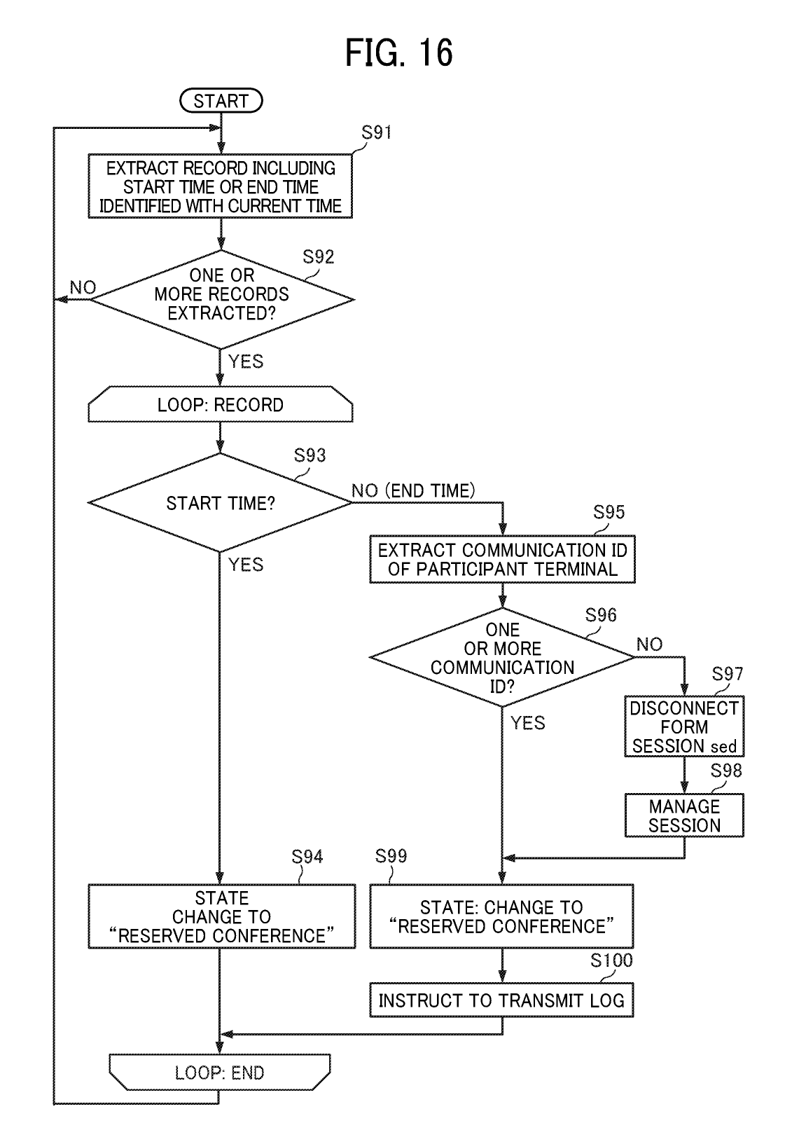

In addition to the above-described process, in the modification B of the example embodiment, the management system 50 has a function of managing the session sed based on the information recorded in the reservation management table. FIG. 16 is a flowchart illustrating an example of the process of managing the session sed, performed by the management system 50. The process according to the modification B of the example embodiment is described with reference to FIG. 16.

The session management unit 54 of the management system 50 searches the reservation management table (see FIG. 14B) using a current time, namely year, month, day, hour, and minute, as a search key, extracts a record including the start time or the end time that is the same as the current time (S91). If no record is extracted in step S91 (NO in S92), the session management unit 54 repeats S91 after one minute, for example, which may be set by a user or a designer, for example.

When the record is extracted in S91 (YES in S92), the session management unit 54 performs a loop process, which is described later, for each extracted record. The session management unit 54 determines whether or not the start time included in the extracted record matches the current time (S93).

When S93 determines that the start time included in the extracted record is identified with the current time (YES in S93), the session management unit 54 changes, in the conference room management table, the state information associated with the conference room ID included in the record extracted in S91 to “RESERVED CONFERENCE” (S94). Even when no terminal 10 participates in the session sed using the reserved conference room ID at the reserved start time, the conference room management table is automatically updated in a manner that the state information associated with the conference room ID selected in the reservation setting is changed to “RESERVED CONFERENCE”.

When S93 determines that the start time included in the extracted record does not match the current time (NO in S93), the end time of the extracted record is to be identified with the current time. In this case, the session management unit 54 searches the conference room management table using the conference room ID included in the extracted record as a search key, and extracts the communication II) of the terminal 10 participating in the corresponding session sed (S95).

The session management unit 54 of the management system 50 determines whether one or more communication IDs of the terminals 10, which are participating in the session sed are extracted in S95 (S96).

If S96 determines that one or more communication Ms of the terminals 10 participating in the session sed are extracted (YES in step S96), the session management unit 54 causes the terminals 10 participating in the session sed to be disconnected from the session sed (step S97).

After the terminals 10, which has participated in the session sed, are disconnected from the session sed, the session management unit 54 of the management system 50 deletes the communication Ms extracted in S95 from a field of the communication IDs corresponding to the participant terminals 10 in the conference room management table (S98).

The session management unit 54 of the management system 50 changes the state information to “VACANT” in the record of which the end time is identified with the current time in the conference room management table (S99). The session management unit 54 further records an end time of the session sed in the record including the conference room ID that had been used with the terminals 10 that has disconnected from the session sed, in the session management table.

The session management unit 54 of the management system 50 transmits an instruction to transmit a log of the chat message including the session ID that is deleted in S99 to the log management unit 55 of the management system 50 (S100).

In response to the instruction, the log management unit 55 of the management system 50 starts preparing for transmitting the log of the chat messages in the same manner as S65, and the transmitting/receiving unit 51 of the management system 50 transmits the log of the chat messages in the same manner as in S66.

Upon completion of S94 or S100, the session management unit 54 of the management system 50 repeats the loop process, and when the loop process is completed, the process returns to S91.

### <<Effects of Embodiments>>

According to the information transmission method of the above-described embodiments, the log management DB 5007 of the management system 50 manages a log of chat messages transmitted by a plurality of communication terminals during the session sed for transmitting the chat messages between or among the plurality of terminals 10 in the communication system 1. The transmitting/receiving unit 51 of the management system 50 receives setting information including an automatic transmission destination from at least one of the plurality of terminals 10 before ending the session sed. The transmitting/receiving unit 51 of the management system 50 transmits the log of the chat messages managed by the log management DB 5007 to the above-mentioned destination based on the setting information received by the transmitting/receiving unit 51. That is, the management system 50 accepts a setting of the log transmission destination by the terminal 10 participating in the session sed before ending the session sed. This prevents the terminal 10 from performing tangled processes, for example, a repeated authentication process in relation to the management system 50 and a process of selecting the log, when obtaining the log at the end of the session sed.

The transmitting/receiving unit 51 of the management system 50 transmits the log to the above-mentioned transmission destination after all of the terminals 10 participating in the session sed are disconnected from the session sed. The management system 50, accordingly, transmit a log including chat messages transmitted after disconnection from the session sed to the terminal 10 that is disconnected from the session sed in the middle of the session sed.

The transmitting/receiving unit 51 of the management system 50 transmits the log to the above-mentioned transmission destination after an elapsed time from when all of the terminals 10 participating in the session sed are disconnected from the session sed exceeds, for example, 10 minutes. The management system 50, accordingly, transmits the log of the chat messages transmitted after reconnecting to the session sed, even when all of the terminals are accidently disconnected from the session sed.

The transmitting/receiving unit 51 of the management system 50 accepts a setting of the end time of the session sed based on reservation information transmitted from the terminal 10. The transmitting/receiving unit 51 of the management system 50 transmits the log to the above-mentioned transmission destination after the end time of the session sed has elapsed based on the setting accepted by the transmitting/receiving unit 51. The management system 50, accordingly, transmits the log including the chat messages transmitted after disconnection of the terminal 10 from the session sed to the terminal 10 before the end time of the reservation.

The transmitting/receiving unit 51 of the management system 50 receives a request for log of chat messages from the terminal 10 participating in the session sed. A user of the terminal 10, accordingly, requests the log of the chat messages according to a level of importance during the conference.

### <<Supplementary Information on Embodiments>>

The programs designed for the management system 50 may be recorded on a computer-readable recording medium for distribution in an installable or executable file format. Examples of such recording medium include, but are not limited to, compact disc-recordable (CD-R), digital versatile disc (DVD), and Blu-ray disc. In addition, the above-described recording medium or a memory, such as a hard disk (HD) storing any one of the above described control programs may be provided in a form of a program product to users within a certain country or the outside of the country.

The management system 50 may be implemented as a single apparatus or a plurality of apparatuses to which divided portions (functions) are assigned.

Each of the functions of the described embodiments may be implemented by one or more processing circuits or circuitry. Processing circuitry includes a programmed processor, as a processor includes circuitry. A processing circuit also includes a device such as an application specific integrated circuit (ASIC), digital signal processor (DSP), field programmable gate array (FPGA), and conventional circuit components arranged to perform the recited functions. The processing circuit herein includes, for example, devices such as a processor that is programmed to execute software to implement functions, like a processor with electronic circuits, an application specific integrated circuit (ASIC) that is designed to execute the above functions, and a circuit module known in the art.

Although the embodiments of the disclosure have been described and illustrated above, such description is not intended to limit the disclosure to the illustrated embodiments. Numerous additional modifications and variations are possible in light of the above teachings. It is therefore to be understood that within the scope of the appended claims, the embodiments may be practiced otherwise than as specifically described herein. For example, elements and/or features of different illustrative embodiments may be combined with each other and/or substituted for each other within the scope of this disclosure and appended claims.

What is claimed is:

1. An information transmission apparatus, comprising circuitry to:
manage a log of content data transmitted by one or more of a plurality of communication terminals during a session, the session being established between the plurality of communication terminals to transmit the content data between the plurality of communication terminals;
receive information on a transmission destination of the log from at least one of the plurality of communication terminals before the session ends; and
transmit the log of content data being managed to the transmission destination based on the received information.

2. The information transmission apparatus of claim 1, wherein the circuitry transmits the log to the transmission destination after all of the plurality of the communication terminals participating in the session are disconnected from the session.

3. The information transmission apparatus of claim 2, wherein, the circuitry transmits the log to the transmission destination after an elapsed time from when all of the plurality of the communication terminals participating in the session are disconnected from the session exceeds a predetermined value.

4. The information transmission apparatus of claim 1, wherein the circuitry is further configured to:
receive information on an end time of the session; and
transmit the log to the transmission destination after the end time, based on the received information on the end time.

5. The information transmission apparatus of claim 1, wherein the circuitry is further configured to receive a request for the log from one or more of the plurality of communication terminals participating in the session.

6. The information transmission apparatus of claim 1, further comprising:
a memory configured to store the log of content data transmitted by one or more of the plurality of communication terminals during the session.

7. A communication system, comprising:
the information transmission apparatus of 1; and
a plurality of communication terminals each of which is configured to transmit content data to the other communication terminals, and
wherein each of the plurality of communication terminals transmits information on transmission destination of a log to the information transmission apparatus before a session ends.

8. A communication system, comprising:
the information transmission apparatus of claim 5; and
a plurality of communication terminals each of which is configured to transmit content data to the other communication terminals, and
wherein each of plurality of communication terminals
transmits information on transmission destination of a log to the information transmission apparatus before a session ends, and
transmits a request for the log to the information transmission apparatus during participating in the session.

9. A method for transmitting information, comprising:
managing a log of content data transmitted by one or more of a plurality of communication terminals during a session, the session being established between the plurality of communication terminals to transmit the content data between the plurality of communication terminals;
receiving information on a transmission destination of the log from at least one of the plurality of communication terminals before the session ends; and
transmitting the log of content data being managed to the transmission destination based on the received information.

10. The method for transmitting information of claim 9, wherein the transmitting the log to the transmission destination transmits the log after all of the plurality of the communication terminals participating in the session are disconnected from the session.

11. The method for transmitting information of claim 10, wherein, the transmitting the log to the transmission destination transmits the log after an elapsed time from when all of the plurality of the communication terminals participating in the session are disconnected from the session exceeds a predetermined value.

12. The method for transmitting information of claim 9, further comprising:
receiving information on an end time of the session; and
transmitting the log to the transmission destination after the end time based on the received information on the end time.

13. The method for transmitting information of claim 9, further comprising receiving a request for the log from one or more of the plurality of communication terminals participating in the session.

14. The method for transmitting information of claim 9, further comprising storing the log of content data transmitted by one or more of the plurality of communication terminals during the session.

15. A non-transitory recording medium storing a plurality of instructions which, when executed by one or more processors, cause the processors to perform a method, comprising:
managing a log of content data transmitted by one or more of a plurality of communication terminals during a session, the session being established between the plurality of communication terminals to transmit the content data between the plurality of communication terminals;
receiving information on a transmission destination of the log from at least one of the plurality of communication terminals before the session ends; and
transmitting the log of content data being managed to the transmission destination based on the received information.
